(19) United States
(12) Patent Application Publication
(10) Pub. No.: US 2025/0301051 A1
(43) Pub. Date: Sep. 25, 2025

(54) CONTENT PUSHING METHOD, READABLE MEDIUM, ELECTRONIC DEVICE AND PRODUCT

(71) Applicant: Beijing Youzhuju Network Technology Co., Ltd., Beijing (CN)

(72) Inventor: Li JIA, Beijing (CN)

(21) Appl. No.: 19/085,920

(22) Filed: Mar. 20, 2025

(30) Foreign Application Priority Data
Mar. 21, 2024 (CN) 202410330688.3

(51) Int. Cl. H04L 67/55

(52) U.S. Cl. CPC H04L 67/55

(57) ABSTRACT

The present disclosure relates to a content pushing method, an apparatus, a readable medium, an electronic device and a product. The method includes: determining a to-be-pushed content; acquiring, from a common field library, a common field corresponding to the to-be-pushed content and a platform field required for displaying the to-be-pushed content on different content platforms, wherein the common field library is configured to store field information related to the to-be-pushed content; determining, according to the to-be-pushed content, the common field and the platform field, a first target content to be pushed to each of the content platforms; and pushing the first target content to each of the content platforms for display.

### CROSS-REFERENCE TO RELATED APPLICATION(S)

The present disclosure claims priority of the Chinese Patent Application No. 202410330688.3 filed on Mar. 21, 2024, the disclosure of which is incorporated herein by reference in its entirety as part of the present application.

### TECHNICAL FIELD

The present disclosure relates to the field of computer technologies, and in particular, to a content pushing method and apparatus, a readable medium, an electronic device and a product.

### BACKGROUND

With the development of computer technologies, more and more content may be pushed to users through content platforms. In order to push content to users through the content platforms, a pusher needs to enter the content into the content platforms first.

However, in the related art, content in a content platform is generally entered manually by a pusher, which has the problems of cumbersome entry process and low entry efficiency.

### SUMMARY

The Summary is provided to introduce concepts in a brief form, and these concepts will be described in detail in the following Detailed Description section. The Summary section is not intended to identify key features or essential features of the claimed technical solution, nor is it intended to be used to limit the scope of the claimed technical solution.

In a first aspect, the present disclosure provides a content pushing method, including:
determining a to-be-pushed content;
acquiring, from a common field library, a common field corresponding to the to-be-pushed content and a platform field required for displaying the to-be-pushed content on different content platforms, wherein the common field library is configured to store field information related to the to-be-pushed content;
determining, according to the to-be-pushed content, the common field and the platform field, a first target content to be pushed to each of the content platforms; and
pushing the first target content to each of the content platforms for display.

In a second aspect, the present disclosure provides a content pushing apparatus, including:
a first determination module, configured to determine a to-be-pushed content;
an obtaining module, configured to acquire, from a common field library, a common field corresponding to the to-be-pushed content and a platform field required for displaying the to-be-pushed content on different content platforms, wherein the common field library is configured to store field information related to the to-be-pushed content;
a second determination module, configured to determine, according to the to-be-pushed content, the common field and the platform field, a first target content to be pushed to each of the content platforms; and
a pushing module, configured to push the first target content to each of the content platforms for display.

In a third aspect, the present disclosure provides a computer-readable medium having a computer program stored thereon, where the computer program, when executed by a processing apparatus, implements any one of the methods in the first aspect.

In a fourth aspect, the present disclosure provides an electronic device, including:
a storage apparatus having a computer program stored thereon; and
a processing apparatus, configured to execute the computer program in the storage apparatus, so as to implement any one of the methods in the first aspect.

In a fifth aspect, the present disclosure provides a computer program product including a computer program, wherein the computer program, when executed by a processor, implements any one of the methods in the first aspect.

Other features and advantages of the present disclosure will be described in detail in the following Detailed Description section.

### BRIEF DESCRIPTION OF DRAWINGS

The above and other features, advantages and aspects of the embodiments of the present disclosure will become more apparent with reference to the following detailed description and in conjunction with the drawings. Throughout the drawings, the same or similar reference numbers denote the same or similar elements. It should be understood that the drawings are schematic and that parts and elements are not necessarily drawn to scale. In the drawings:

FIG. 1 is a flowchart of a content pushing method according to an exemplary embodiment of the present disclosure;

FIG. 2 is a schematic diagram of determining a common field and a platform field according to an exemplary embodiment of the present disclosure;

FIG. 3 is a flowchart block diagram of a content pushing method according to an exemplary embodiment of the present disclosure;

FIG. 4 is a schematic block diagram of updating target content and/or a common field library according to an exemplary embodiment of the present disclosure;

FIG. 5 is a structural block diagram of a content pushing apparatus according to an exemplary embodiment of the present disclosure; and

FIG. 6 is a schematic structural diagram of an electronic device according to an exemplary embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms and should not be construed as limited to the embodiments set forth herein. On the contrary, these embodiments are provided for a thorough and complete understanding of the present disclosure. It should be understood that the drawings and the embodiments of the present disclosure are only for exemplary purposes, and are not intended to limit the protection scope of the present disclosure.

It should be understood that the various steps described in the implementation modes of the method the present disclosure can be performed in different orders, and/or performed in parallel. In addition, the implementation modes of the method may include additional steps and/or steps omitted or unshown. The scope of the present disclosure is not limited in this respect.

The term “include” and variations thereof used herein are open-ended inclusions, that is, “include but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms will be given in the description below.

It should be noted that concepts such as “first” and “second” mentioned in the present disclosure are only used to distinguish different apparatuses, modules or units, and are not intended to limit the order or interdependence relationship of functions performed by these apparatuses, modules or units.

It should be noted that the modifications of “one” and “more” mentioned in the present disclosure are illustrative rather than restrictive, and those skilled in the art should understand that unless the context clearly indicates otherwise, they should be understood as “one or more”.

The names of messages or information exchanged between multiple apparatuses in the embodiments of the present disclosure are only used for illustrative purposes, and are not used to limit the scope of these messages or information.

It can be understood that, before using the technical solutions disclosed in the embodiments of the present disclosure, the types, scope of use, and usage scenarios of personal information involved in the present disclosure and the like shall be informed to the user and the user's authorization shall be obtained in an appropriate manner in accordance with relevant laws and regulations.

For example, when receiving an active request from a user, prompt information is sent to the user, so as to clearly prompt the user that the operation requested to be performed will require the acquisition and use of the user's personal information. Thus, the user can independently choose whether to provide the personal information to software or hardware such as an electronic device, an application, a server or a storage medium that performs the operation of the technical solution of the present disclosure according to the prompt information.

As an optional but non-limiting implementation, in response to receiving an active request from a user, the prompt information may be sent to the user in a pop-up window, for example, and the prompt information may be presented in the pop-up window in a text form. In addition, the pop-up window may also carry a selection control for the user to select “agree” or “disagree” to provide personal information to the electronic device.

It can be understood that the above process of notifying and acquiring the user's authorization is only illustrative, and does not limit the implementation of the present disclosure. Other manners that meet relevant laws and regulations may also be applied to the implementations of the present disclosure.

It can also be understood that the data (including but not limited to the data itself, the acquisition or use of the data) involved in the technical solution shall comply with the requirements of corresponding laws, regulations and relevant provisions.

As mentioned in the background art, with the development of computer technologies, more and more content, such as texts, pictures, videos or audios, may be pushed to various users through content platforms. In order to push content to users through the content platforms, a pusher needs to enter the content into the content platforms first.

However, in the related art, content in a content platform is generally entered manually by a pusher, and the entry process is cumbersome and the entry efficiency is low.

Specifically, if there are multiple content platforms that need to be entered, the pusher needs to enter the content multiple times, which makes the entry process cumbersome and the entry efficiency low. In addition, if there are differences in core user groups or in displayed content of respective content platform, the pusher also needs to enter different contents into the content platforms according to the core user groups or the displayed contents of each content platform, which makes the entry process complex. In addition, if content that have been entered into the content platforms need to be updated, the content in each content platform also need to be updated, which makes the update process cumbersome and complex.

Exemplarily, a core user group of a content platform 1 is female users, and a core user group of a content platform 2 is male users. For the same content to be entered, such as an electronic product introduction document, female users and male users have different focuses on the electronic product introduction document. Therefore, when entering the electronic product introduction document into the content platform 1 and the content platform 2, the related art will extract content that female users are interested in from the electronic product introduction document and enter it into the content platform 1, and extract content that male users are interested in from the electronic product introduction document and enter it into the content platform 2. Therefore, when the same electronic product introduction document is entered into different content platforms, it is not only necessary to enter the electronic product introduction document multiple times, but also to extract different contents from the electronic product introduction document to enter according to the characteristics of the content platforms, which makes the entry process cumbersome and complex and the entry efficiency low.

In view of this, the present disclosure provides a content pushing method and apparatus, a readable medium, an electronic device and a product to solve the above technical problems.

The embodiments of the present disclosure will be further explained below with reference to the drawings.

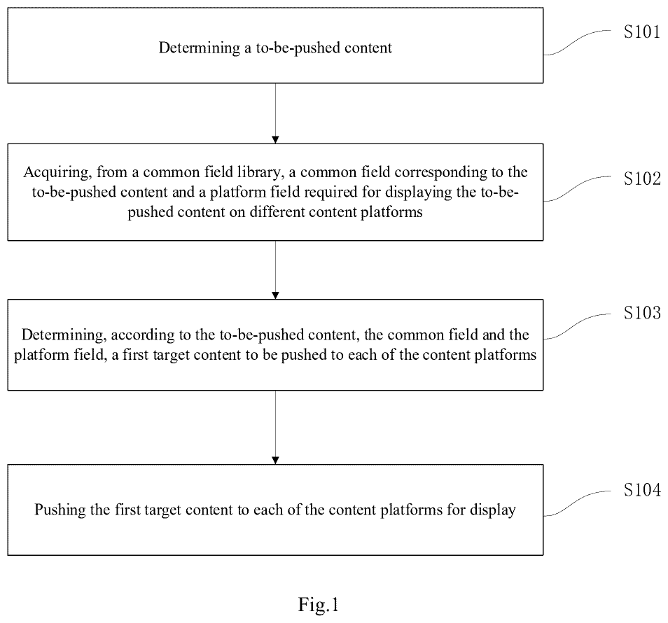

FIG. 1 is a flowchart of a content pushing method according to an exemplary embodiment of the present disclosure. Referring to FIG. 1, the method may include the following steps.

S101: determining a to-be-pushed content.

The to-be-pushed content is determined according to an actual application scenario, and the embodiment of the present disclosure is not limited thereto. In a possible implementation, the to-be-pushed content may be physical commodity content and/or service commodity content.

When the to-be-pushed content is the physical commodity content, the to-be-pushed content may be a description content of a physical commodity. Exemplarily, it may be a description content of a size, a material, a brand, a performance and/or a core function of an electronic product. When the to-be-pushed content is the service commodity content, the to-be-pushed content may be a description content of a service commodity. Exemplarily, it may be a description content of a photography duration, a photography number, a clothing set number, a photography style and/or a photography place of a photography service.

S102: acquiring, from a common field library, a common field corresponding to the to-be-pushed content and a platform field required for displaying the to-be-pushed content on different content platforms, wherein the common field library is configured to store field information related to the to-be-pushed content.

It should be understood that the common field refers to a field that is displayed on different content platforms, and the platform field refers to a non-common field that is displayed on a single content platform.

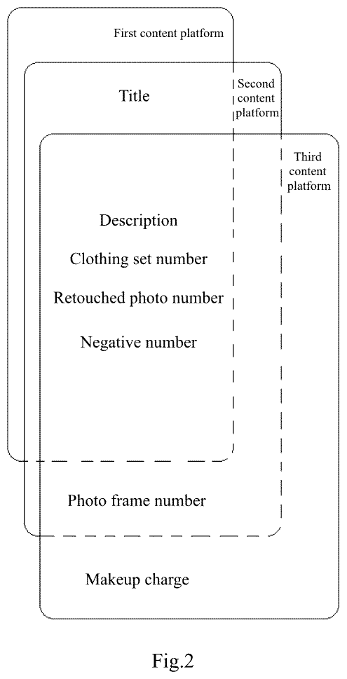

Exemplarily, as shown in FIG. 2, in a photography service, there are fields for title, description, clothing set number, retouched photo number, negative number, photo frame number, and makeup charge, and there are a first content platform, a second content platform and a third content platform. The first content platform, the second content platform and the third content platform may all display the fields for description, clothing set number, retouched photo number and negative number, and therefore the description field, the fields for description, clothing set number, retouched photo number and negative number are common fields. The title field is only displayed on the first content platform and the second content platform, the photo frame number field is only displayed on the second content platform, and the makeup charge field is only displayed on the third content platform. Therefore, the title field is a platform field of the first content platform and the second content platform, the photo frame number field is a platform field of the second content platform, and the makeup charge field is a platform field of the third content platform.

In addition, it should be understood that field information stored in the common field library may be the field information corresponding to the same content type, or may be the field information corresponding to different content types, and the embodiment of the present disclosure may not be limited thereto.

When the field information stored in the common field library is the field information corresponding to different content types, for each preset content type, statistical analysis may be performed in advance on all field information in visual contents with the same content type on different content platforms, to obtain a common field and a platform field displayed on different content platforms for each content type, and then the common field library is constructed according to a correspondence among the content type, the common field and the platform field, each content type, the common field corresponding to each content type and the platform field corresponding to each content type. In this way, if it is necessary to quickly acquire the common field and the platform field corresponding to the to-be-pushed content from the common field library, a content type of the to-be-pushed content may be determined first, and then the corresponding common field and platform field are acquired from the common field library according to the content type.

That is, according to an embodiment of the present disclosure, the acquiring, from a common field library, a common field corresponding to the to-be-pushed content and a platform field required for displaying the to-be-pushed content on different content platforms may include:
determining a content type of the to-be-pushed content; and searching, according to the content type, the common field corresponding to the to-be-pushed content and the platform field required for displaying the to-be-pushed content on the different content platforms in the common field library.

When the field information stored in the common field library is the field information corresponding to the same content type, a content type of the to-be-pushed content may be determined first, then visual content with the same content type is acquired from different content platforms according to the content type of the to-be-pushed content, and statistical analysis is performed on all field information in the acquired visual content, so as to obtain the common field and the platform field displayed on different content platforms that correspond to the content type, thereby constructing the common field library according to the content type, the common field, and the platform field displayed on different content platforms.

That is, according to an embodiment of the present disclosure, the field information in the common field library may be obtained by:
determining visual content, of which a content type is the same as that of the to-be-pushed content, displayed to a user on different content platforms; determining a same first field when each of the content platforms displays corresponding visual content, and determining a different second field when each of the content platforms displays the corresponding visual content; and storing the first field into the common field library as the common field, and storing the second field into the common field library as the platform field of each of the content platforms.

In this way, since the common field library is constructed in real time according to the content type of the to-be-pushed content, the accuracy of the field information in the common field library can be ensured, thereby improving the accuracy of the common field and the platform field corresponding to the to-be-pushed content.

S103: determining, according to the to-be-pushed content, the common field and the platform field, a first target content to be pushed to each of the content platforms.

In a possible implementation, the determining, according to the to-be-pushed content, the common field and the platform field, a first target content to be pushed to each of the content platforms may include:
determining first sub-content required for the common field in the to-be-pushed content; determining second sub-content required for each platform field in the to-be-pushed content; and determining a field value of the common field according to the first sub-content, and determining a field value of each platform field according to the second sub-content to obtain the first target content to be pushed to each of the content platforms.

The first sub-content is used to represent the content related to the common field in the to-be-pushed content, and the second sub-content is used to represent the content related to the platform field in the to-be-pushed content, which is specifically determined according to actual situations, and the embodiment of the present disclosure does not make any limitation here.

Exemplarily, the to-be-pushed content is “Wedding dress photography service: the photography style is optional, and 4 sets of clothes, 200 photos, all photography negatives, 25 retouched photos, and 6 additional photo frames, including 3 large photo frames and 3 small photo frames, are provided”. The common field is the clothing set number, the retouched photo number, the photography style, and the negative number. The platform field of the first content platform and the third content platform is the title, and the platform field of the second content platform is the photo frame number. Then, the first sub-content may include “the photography style is optional, and 4 sets of clothes, 200 photos, all photography negatives, 25 retouched photos are provided”, the second sub-content of the first content platform and the third content platform may include “Wedding dress photography service”, and the second sub-content of the second content platform may include “and 6 additional photo frames, including 3 large photo frames and 3 small photo frames, are provided”.

The field value is used to represent the field content corresponding to the common field or the platform field, which is specifically determined according to actual situations, and the embodiment of the present disclosure does not make any limitation here.

Exemplarily, the common field is the clothing set number, the retouched photo number, the photography style, and the negative number, and the first sub-content is “the photography style is optional, and 4 sets of clothes, 200 photos, all photography negatives, 25 retouched photos are provided”. Then, the field value corresponding to the clothing set number may be: 4 sets; the field value corresponding to the retouched photo number may be: 25 photos; the field value corresponding to the photography style may be: optional; and the field value corresponding to the negative number may be: 200 photos, all photography negatives.

Exemplarily, the platform field of the first content platform and the third content platform is the title, and the second sub-content corresponding to the first content platform and the third content platform is “Wedding dress photography service”. Then, the field value corresponding to the title may be: wedding dress photography service. The platform field of the second content platform is the photo frame number, and the second sub-content corresponding to the second content platform is “6 additional photo frames, including 3 large photo frames and 3 small photo frames”. Then, the field value corresponding to the photo frame number may be: 6 photo frames, including 3 large photo frames and 3 small photo frames.

Therefore, after the field value of the common field and the field values of the platform fields are determined in the above manner, the first target content of each content platform can be determined according to the common field, the field value of the common field, the platform field, and the field value of the platform field.

Exemplarily, the first target content corresponding to the first content platform may include “Title: wedding dress photography service; clothing set number: 4 sets; retouched photo number: 25 photos; photography style: optional; negative number: 200 photos, all photography negatives”. The first target content corresponding to the second content platform may include “Clothing set number: 4 sets; retouched photo number: 25 photos; photography style: optional; negative number: 200 photos, all photography negatives; photo frame number: 6 photo frames, including 3 large photo frames and 3 small photo frames”. The first target content corresponding to the third content platform may include “Title: wedding dress photography service; clothing set number: 4 sets; retouched photo number: 25 photos; photography style: optional; negative number: 200 photos, all photography negatives”.

S104: pushing the first target content to each of the content platforms for display.

Through the above technical solutions, after the to-be-pushed content is determined, the first target content may be first generated according to the to-be-pushed content and the field related to the to-be-pushed content in the common field library, and then the first target content is pushed to each of the content platforms for display. Therefore, after the to-be-pushed content is determined, the first target content may be automatically generated and pushed to multiple content platforms. Compared with the case where a user manually enters content into a content platform in the related art, the present disclosure can simplify the entry process and improve the entry efficiency. In addition, when the first target content is generated, the platform field required for displaying the to-be-pushed content on different content platforms may be combined, so that the first target content displayed on each of the content platforms is more suitable for the content platform.

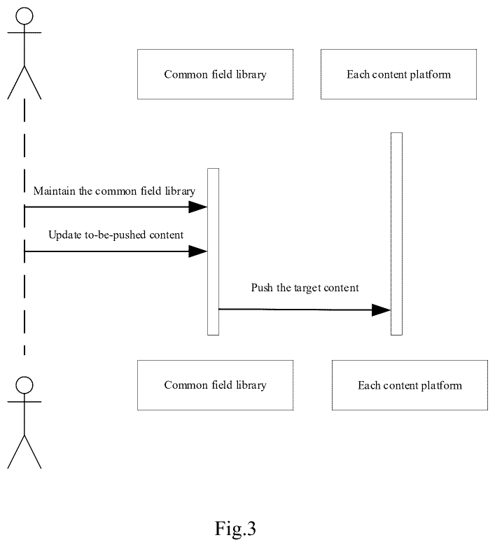

In a possible implementation, as shown in FIG. 3, the method may further include:
when the to-be-pushed content is updated, updating a field value of the common field corresponding to the to-be-pushed content in the common field library and/or updating a field value of the platform field corresponding to the to-be-pushed content in the common field library, to obtain a second target content to be pushed to each of the content platforms; and updating and displaying the first target content displayed on each of the content platforms, according to the second target content.

It should be understood that the field value of the common field and/or the field value of the platform field corresponding to the to-be-pushed content in the common field library may be stored after the field value of the common field is determined according to the first sub-content and/or the field value of the platform field is determined according to the second sub-content, or may be stored after the first target content of each of the content platforms is determined. The embodiment of the present disclosure does not make any limitation here.

Exemplarily, continuing to refer to the above example, after the field value of the common field and the field value of each of the platform fields are determined according to the to-be-pushed content, the field value of the common field and the field value of each of the platform fields are stored in the common field library. When the to-be-pushed content is updated from “Wedding dress photography service: the photography style is optional, and 4 sets of clothes, 200 photos, all photography negatives, 25 retouched photos, and 6 additional photo frames, including 3 large photo frames and 3 small photo frames, are provided” to “Wedding dress photography service: the photography style is optional, and 6 sets of clothes, 300 photos, all photography negatives, 30 retouched photos, and 6 additional photo frames, including 3 large photo frames and 3 small photo frames, are provided”, the corresponding field values in the common field library is first changed, that is, the field value corresponding to the clothing set number is updated from 4 sets to 6 sets, the field value corresponding to the negative number is updated from 200 photos, all photography negatives to 300 photos, all photography negatives, and the field value corresponding to the retouched photo number is updated from 25 photos to 30 photos. Then, the second target content of each of the content platforms is obtained according to the updated field values in the common field library, and the first target content displayed on each of the content platforms is updated to the second target content for display.

It should be understood that this is only a schematic illustration and does not constitute a limitation on the solution. When the updated field values are not the field values of the common field, only the first target content of the content platform corresponding to the platform field may be updated and displayed.

Exemplarily, continuing to refer to the above example, when the to-be-pushed content is updated from “Wedding dress photography service: the photography style is optional, and 4 sets of clothes, 200 photos, all photography negatives, 25 retouched photos, and 6 additional photo frames, including 3 large photo frames and 3 small photo frames, are provided” to “Wedding dress photography service: the photography style is optional, and 4 sets of clothes, 200 photos, all photography negatives, 25 retouched photos, and 6 additional photo frames, including 1 photo frame of 50 cm*50 cm, 1 photo frame of 50 cm*75 cm, and 4 photo frames of 20 cm*20 cm, are provided”, the field value corresponding to the photo frame number in the common field library may be updated from “6 photo frames, including 3 large photo frames and 3 small photo frames” to “6 photo frames, including 1 photo frame of 50 cm*50 cm, 1 photo frame of 50 cm*75 cm, and 4 photo frames of 20 cm*20 cm”, so as to obtain the second target content of the second content platform according to the updated field value in the common field library, and update the first target content corresponding to the second content platform to the second target content. That is, “Clothing set number: 4 sets; retouched photo number: 25 photos; photography style: optional; negative number: all photography negatives; photo frame number: 6 photo frames, including 3 large photo frames and 3 small photo frames” is updated to “Clothing set number: 4 sets; retouched photo number: 25 photos; photography style: optional; negative number: all photography negatives; photo frame number: 6 photo frames, including 1 photo frame of 50 cm*50 cm, 1 photo frame of 50 cm*75 cm, and 4 photo frames of 20 cm*20 cm”.

It should be understood that this is only a schematic illustration and does not constitute a limitation on the solution. In a possible implementation, in order to reduce the amount of data update and improve the update speed, only the field value that has changed in the first target content may be updated.

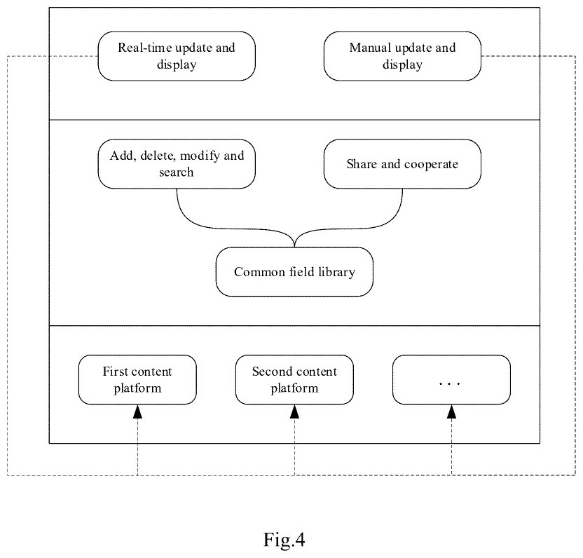

In a possible implementation, as shown in FIG. 3 and FIG. 4, the updating and displaying the first target content displayed on each of the content platforms, according to the second target content includes:
updating and displaying the first target content displayed on each of the content platforms in real time, according to the second target content; or displaying content update prompt information, and updating and displaying, in response to an update operation triggered by a user, the first target content displayed on each of the content platforms, according to the second target content.

The updating and displaying the first target content in real time is automatic update. Once it is detected that the to-be-pushed content is updated, the first target content displayed on each of the content platforms is automatically updated to the second target content for display. The updating and displaying, in response to an update operation triggered by a user, the first target content displayed on each of the content platforms, according to the second target content, is manual update, and whether to update is determined by the user.

The content update prompt information may be determined according to actual situations, and the embodiment of the present disclosure does not make any limitation here. Exemplarily, the update prompt information may be set as “A field value in the common field library has been updated. Whether to synchronously update a field value in a content platform?”, “Whether to update the first target content in all content platforms?”, or “Please select a content platform that needs to update the first target content”, etc.

In a possible implementation, as shown in FIG. 3 and FIG. 4, the method may further include:
adding, in response to a field addition operation, the common field and/or the platform field corresponding to the to-be-pushed content in the common field library; or, querying, in response to a field edit operation, the common field and/or the platform field corresponding to the to-be-pushed content in the common field library, and editing the common field and/or the platform field that are queried, according to the field edit operation.

The field edit operation may be a modification operation, a deletion operation and/or a search operation on the common field and/or the platform field, which is specifically determined according to actual situations, and the embodiment of the present disclosure does not make any limitation here.

In this embodiment, by providing the field addition function and the field edit function, a user may perform an addition operation, a modification operation, a search operation, a deletion operation or the like on the common field and/or the platform field according to actual situations, so that a final target content generated according to the push content, the common field and the platform field is more in line with the needs of the user, and the accuracy and novelty of the target content are increased while improving the user experience.

In a possible implementation, a field corresponding to the to-be-pushed content in the common field library has a field operation permission, and as shown in FIG. 3 and FIG. 4, the method may further include:
sharing, in response to an operation of authorizing the field operation permission of the to-be-pushed content to a target user, the common field and/or the platform field corresponding to the to-be-pushed content with a terminal device of the target user, and allowing the target user to modify the common field and/or the platform field corresponding to the to-be-pushed content.

The field operation permission may be a field sharing permission, a field viewing permission and/or a field editing permission, etc., which may be specifically determined according to actual situations, and the embodiment of the present disclosure does not make any limitation here.

In this embodiment, the field operation permission of the to-be-pushed content may be authorized to the target user, and the target user may be allowed to modify the common field and/or the platform field corresponding to the to-be-pushed content, so that different users may cooperatively edit the common field and/or the platform field corresponding to the to-be-pushed content, which can improve the editing flexibility of the common field and/or the platform field and improve the pushing efficiency on the one hand, and can improve the accuracy of the common field and/or the platform field on the other hand. Thus, the final target content generated according to the push content, the common field and the platform field is more in line with the needs of the user.

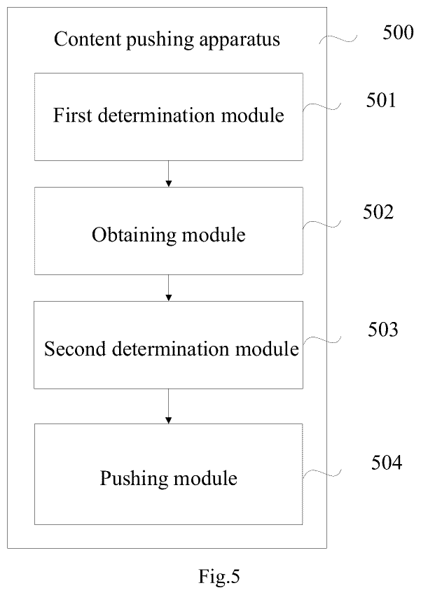

Based on the same concept, an embodiment of the present disclosure further provides a content pushing apparatus. As shown in FIG. 5, the content pushing apparatus 500 may include:
a first determination module 501, configured to determine a to-be-pushed content;
an obtaining module 502, configured to acquire, from a common field library, a common field corresponding to the to-be-pushed content and a platform field required for displaying the to-be-pushed content on different content platforms, where the common field library is configured to store field information related to the to-be-pushed content;
a second determination module 503, configured to determine, according to the to-be-pushed content, the common field and the platform field, a first target content to be pushed to each of the content platforms; and
a pushing module 504, configured to push the first target content to each of the content platforms for display.

Through the content pushing apparatus 500, after the to-be-pushed content is determined, the first target content may be first generated according to the to-be-pushed content and the field related to the to-be-pushed content in the common field library, and then the first target content is pushed to each of the content platforms for display. Therefore, after the to-be-pushed content is determined, the first target content may be automatically generated and pushed to multiple content platforms. Compared with the case where a user manually enters content into a content platform in the related art, the present disclosure can simplify the entry process and improve the entry efficiency. In addition, when the first target content is generated, the platform field required for displaying the to-be-pushed content on different content platforms may be combined, so that the first target content displayed on each of the content platforms is more suitable for the content platform.

In a possible implementation, the obtaining module 502 may include:
a first determination unit, configured to determine a content type of the to-be-pushed content; and
a search unit, configured to search, according to the content type, the common field corresponding to the to-be-pushed content and the platform field required for displaying the to-be-pushed content on the different content platforms in the common field library.

In a possible implementation, the second determination module 503 may include:
a second determination unit, configured to determine first sub-content required for the common field in the to-be-pushed content;
a third determination unit, configured to determine second sub-content required for each of the platform fields in the to-be-pushed content; and
a fourth determination unit, configured to determine a field value of the common field according to the first sub-content, and determine a field value of each of the platform fields according to the second sub-content, so as to obtain the first target content to be pushed to each of the content platforms.

In a possible implementation, the content pushing apparatus 500 may further include:
a first update module, configured to, when the to-be-pushed content is updated, update a field value of the common field corresponding to the to-be-pushed content in the common field library and/or update a field value of the platform field corresponding to the to-be-pushed content in the common field library, to obtain a second target content to be pushed to each of the content platforms; and
a second update module, configured to update and display the first target content displayed on each of the content platforms, according to the second target content.

In a possible implementation, the second update module may include:
a first update unit, configured to update and display the first target content displayed on each of the content platforms in real time, according to the second target content; or
a second update unit, configured to display content update prompt information, and update and display, in response to an update operation triggered by a user, the first target content displayed on each of the content platforms, according to the second target content.

In a possible implementation, the content pushing apparatus 500 may further include:
an addition module, configured to add, in response to a field addition operation, the common field and/or the platform field corresponding to the to-be-pushed content in the common field library; or
an edit module, configured to query, in response to a field edit operation, the common field and/or the platform field corresponding to the to-be-pushed content in the common field library, and edit the common field and/or platform field that are queried, according to the field edit operation.

In a possible implementation, a field corresponding to the to-be-pushed content in the common field library has a field operation permission, and the content pushing apparatus 500 may further include:
a sharing module, configured to share, in response to an operation of authorizing the field operation permission of the to-be-pushed content to a target user, the common field and/or the platform field corresponding to the to-be-pushed content with a terminal device of the target user, and allow the target user to modify the common field and/or the platform field corresponding to the to-be-pushed content.

In a possible implementation, the field information in the common field library is obtained by:
determining visual content, of which a content type is the same as that of the to-be-pushed content, displayed to a user on different content platforms;
determining a same first field when each of the content platforms displays corresponding visual content, and determining a different second field when each of the content platforms displays the corresponding visual content; and
storing the first field into the common field library as the common field, and storing the second field into the common field library as the platform field of each of the content platforms.

In a possible implementation, the to-be-pushed content is physical commodity content and/or service commodity content.

Regarding the content pushing apparatus 500 in the above embodiment, the specific manner in which the modules perform operations has been described in detail in the embodiments of the method, and will not be described in detail here.

Based on the same concept, an embodiment of the present disclosure further provides a computer-readable medium having a computer program stored thereon, wherein the computer program, when executed by a processing apparatus, implements any one of the methods in the first aspect.

Based on the same concept, an embodiment of the present disclosure further provides an electronic device, which may include:
a storage apparatus having a computer program stored thereon; and
a processing apparatus, configured to execute the computer program in the storage apparatus to implement any one of the methods in the first aspect.

Based on the same concept, an embodiment of the present disclosure further provides a computer program product including a computer program, wherein the computer program, when executed by a processor, implements any one of the methods in the first aspect.

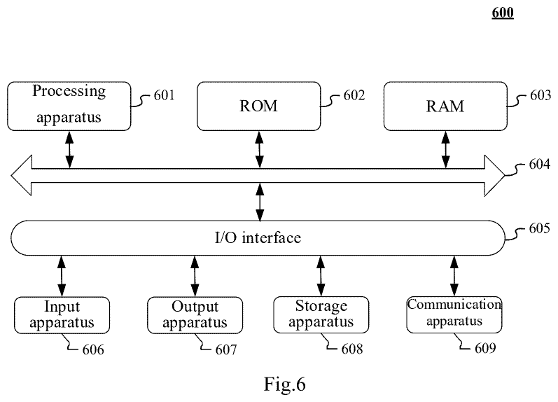

Reference is made to FIG. 6 below, which illustrates a schematic structural diagram of an electronic device 600 suitable for implementing embodiments of the present disclosure. The terminal device in the embodiments of the present disclosure may include, but are not limited to, mobile terminals such as a mobile phone, a notebook computer, a digital broadcasting receiver, a personal digital assistant (PDA), a tablet computer (PAD), a portable multimedia player (PMP), a vehicle-mounted terminal (e.g., a vehicle-mounted navigation terminal), etc., and fixed terminals such as a digital TV, a desktop computer, etc. The electronic device shown in FIG. 6 is only an example, and should not bring any limitation to the functions and the range of use of the embodiments of the present disclosure.

As shown in FIG. 6, the electronic device 600 may include a processing apparatus 601 (such as a central processing unit, a graphics processing unit, etc.), which can perform various appropriate actions and processes according to a program stored in a read-only memory (ROM) 602 or a program loaded from a storage apparatus 608 into a random access memory (RAM) 603. In the RAM 603, various programs and data required for the operation of the electronic device 600 are also stored. The processing apparatus 601, the ROM 602, and the RAM 603 are interconnected by means of a bus 604. An input/output (I/O) interface 605 is also connected to the bus 604.

Usually, the following apparatuses can be connected to the I/O interface 605: an input apparatus 606 including, for example, a touch screen, a touch pad, a keyboard, a mouse, a camera, a microphone, an accelerometer, a gyroscope, etc.; an output apparatus 607 including, for example, a liquid crystal display (LCD), a loudspeaker, a vibrator, etc.; a storage apparatus 608 including, for example, a magnetic tape, a hard disk, etc.; and a communication apparatus 609. The communication apparatus 609 can allow the electronic device 600 to perform wireless or wired communication with other devices to exchange data. Although FIG. 6 shows the electronic device 600 having various apparatuses, it should be understood that not all of the illustrated apparatuses are necessarily implemented or included. More or fewer apparatuses may be implemented or included alternatively.

In particular, according to embodiments of the present disclosure, the processes described above with reference to the flowchart can be implemented as a computer software program. For example, an embodiment of the present disclosure includes a computer program product, which includes a computer program carried by a non-transitory computer-readable medium, and the computer program includes program codes for performing the method shown in the flowchart. In such embodiments, the computer program may be downloaded and installed from the network through the communication apparatus 609, or installed from the storage apparatus 608, or installed from the ROM 602. When the computer program is executed by the processing apparatus 601, the above functions defined in the method of the embodiments of the present disclosure are performed.

It should be noted that the above computer-readable medium in the present disclosure may be a computer-readable signal medium or a computer-readable storage medium or any combination thereof. The computer-readable storage medium may be, for example, but not limited to, an electric, magnetic, optical, electromagnetic, infrared, or semiconductor system, apparatus, or device, or any combination thereof. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of them. In the present disclosure, the computer-readable storage medium may be any tangible medium containing or storing a program, and the program may be used by or in combination with an instruction execution system, apparatus, or device. In the present disclosure, the computer-readable signal medium may include a data signal propagated in a baseband or as a part of a carrier and carries computer-readable program codes. The propagated data signal may take many forms, including, but not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including, but not limited to: an electric wire, an fiber-optic cable, RF (radio frequency), etc., or any suitable combination of them.

In some implementations, any network protocol currently known or to be researched and developed in the future such as HTTP (HyperText Transfer Protocol) may be used for communication, and digital data communication (for example, communication network) in any form or medium may be interconnected. Examples of the communication network include a Local Area Network (“LAN”), a wide area network (“WAN”), an internetwork (for example, the Internet), and an end-to-end network (for example, an ad hoc end-to-end network), as well as any network currently known or to be researched and developed in the future.

The above computer-readable medium may be included in the above electronic device, or may also exist alone without being assembled into the electronic device.

The computer-readable medium carries one or more programs, and when the one or more programs are executed by the electronic device, the electronic device is caused to: determine a to-be-pushed content; acquire, from a common field library, a common field corresponding to the to-be-pushed content and a platform field required for displaying the to-be-pushed content on different content platforms, wherein the common field library is configured to store field information related to the to-be-pushed content; determine, according to the to-be-pushed content, the common field and the platform field, a first target content to be pushed to each of the content platforms; and push the first target content to each of the content platforms for display.

The computer program codes for performing the operations of the present disclosure may be written in one or more programming languages or a combination thereof, wherein the above programming languages include but are not limited to object-oriented programming languages such as Java, Smalltalk, C++, and also include conventional procedural programming languages such as “C” programming language or similar programming languages. The program code may be executed entirely on the user's computer, partly on the user's computer, as an independent software package, partly on the user's computer and partly on a remote computer, or entirely on the remote computer or server. In the case of involving the remote computer, the remote computer may be connected to the user's computer through any kind of network, including a local area network (LAN) or a wide area network (WAN), or the connection may be made to an external computer (for example, through the Internet by using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code, and the module, the program segment, or the part of code contains one or more executable instructions for implementing a specified logical function. It should also be noted that, in some alternative implementations, the functions marked in the blocks may also occur in a different order from the order marked in the drawings. For example, two blocks shown in succession may actually be executed substantially in parallel, and they may sometimes be executed in the reverse order, depending on the functionality involved. It should also be noted that each block in the block diagram and/or flowchart, and the combination of blocks in the block diagram and/or flowchart, can be implemented by a dedicated hardware-based system that performs the specified functions or operations, or can be implemented by a combination of dedicated hardware and computer instructions.

The modules involved in the embodiments of the present disclosure may be implemented in software or hardware. The name of the module does not constitute a limitation on the module itself under certain circumstances.

The functions described herein above may be performed at least in part by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only a preferred embodiment of the present disclosure and an explanation of the applied technical principle. Those skilled in the art should understand that the scope of disclosure involved in the present disclosure is not limited to the technical solution formed by the specific combination of the above technical features, and should also cover other technical solutions formed by the arbitrary combination of the above technical features or their equivalent features without departing from the above disclosed concept. For example, a technical solution formed by exchanging the above features with technical features with similar functions disclosed in the present disclosure (but not limited thereto).

In addition, although operations have been described in a particular order, it shall not be construed as requiring these operations to be performed in the specific order shown or in a sequential order. Under certain circumstances, multitasking and parallel processing may be advantageous. Similarly, although several specific implementation details are included in the above discussion, these shall not be construed as limitations to the present disclosure. Certain features described in the context of a single embodiment can also be implemented in a single embodiment in combination. On the contrary, various features described in the context of a single embodiment can also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are only exemplary forms for implementing the claims. Regarding the apparatus in the above embodiment, the specific manner in which the modules perform operations has been described in detail in the embodiments of the method, and will not be described in detail here.

1. A content pushing method, comprising:
determining a to-be-pushed content;
acquiring, from a common field library, a common field corresponding to the to-be-pushed content and a platform field required for displaying the to-be-pushed content on different content platforms, wherein the common field library is configured to store field information related to the to-be-pushed content;
determining, according to the to-be-pushed content, the common field and the platform field, a first target content to be pushed to each of the content platforms; and
pushing the first target content to each of the content platforms for display.

2. The content pushing method according to claim 1, wherein the acquiring, from a common field library, a common field corresponding to the to-be-pushed content and a platform field required for displaying the to-be-pushed content on different content platforms comprises:
determining a content type of the to-be-pushed content; and
searching, according to the content type, the common field corresponding to the to-be-pushed content and the platform field required for displaying the to-be-pushed content on the different content platforms in the common field library.

3. The content pushing method according to claim 1, wherein the determining, according to the to-be-pushed content, the common field and the platform field, a first target content to be pushed to each of the content platforms comprises:
determining first sub-content required for the common field in the to-be-pushed content;
determining second sub-content required for each of the platform fields in the to-be-pushed content; and
determining a field value of the common field according to the first sub-content, and determining a field value of each of the platform fields according to the second sub-content to obtain the first target content to be pushed to each of the content platforms.

4. The content pushing method according to claim 3, wherein the method further comprises:
when the to-be-pushed content is updated, updating a field value of the common field corresponding to the to-be-pushed content in the common field library and/or updating a field value of the platform field corresponding to the to-be-pushed content in the common field library, to obtain a second target content to be pushed to each of the content platforms; and
updating and displaying the first target content displayed on each of the content platforms, according to the second target content.

5. The content pushing method according to claim 4, wherein the updating and displaying the first target content displayed on each of the content platforms, according to the second target content comprises:
updating and displaying the first target content displayed on each of the content platforms in real time, according to the second target content; or
displaying content update prompt information, and updating and displaying, in response to an update operation triggered by a user, the first target content displayed on each of the content platforms, according to the second target content.

6. The content pushing method according to claim 1, wherein the method further comprises:
adding, in response to a field addition operation, the common field and/or the platform field corresponding to the to-be-pushed content in the common field library; or
querying, in response to a field edit operation, the common field and/or the platform field corresponding to the to-be-pushed content in the common field library, and editing the common field and/or the platform field that are queried, according to the field edit operation.

7. The content pushing method according to claim 1, wherein a field corresponding to the to-be-pushed content in the common field library has a field operation permission, and the method further comprises:
sharing, in response to an operation of authorizing the field operation permission of the to-be-pushed content to a target user, the common field and/or the platform field corresponding to the to-be-pushed content with a terminal device of the target user, and allowing the target user to modify the common field and/or the platform field corresponding to the to-be-pushed content.

8. The content pushing method according to claim 1, wherein the field information in the common field library is obtained by:
determining visual content, of which content types are the same as that of the to-be-pushed content, displayed to a user on different content platforms;
determining a same first field when each of the content platforms displays corresponding visual content, and determining a different second field when each of the content platforms displays the corresponding visual content; and
storing the first field into the common field library as the common field, and storing the second field into the common field library as the platform field of each of the content platforms.

9. The content pushing method according to claim 1, wherein the to-be-pushed content is physical commodity content and/or service commodity content.

10. A computer-readable medium having a computer program stored thereon, wherein the computer program, when executed by a processing apparatus, implements the method according to claim 1.

11. An electronic device, comprising:
a storage apparatus having a computer program stored thereon; and
a processing apparatus, configured to execute the computer program in the storage apparatus, so as to implement the method according to claim 1.

12. A computer program product comprising a computer program, wherein the computer program, when executed by a processor, implements the method according to claim 1.

13. The electronic device according to claim 11, wherein the acquiring, from a common field library, a common field corresponding to the to-be-pushed content and a platform field required for displaying the to-be-pushed content on different content platforms comprises:
determining a content type of the to-be-pushed content; and
searching, according to the content type, the common field corresponding to the to-be-pushed content and the platform field required for displaying the to-be-pushed content on the different content platforms in the common field library.

14. The electronic device according to claim 11, wherein the determining, according to the to-be-pushed content, the common field and the platform field, a first target content to be pushed to each of the content platforms comprises:
determining first sub-content required for the common field in the to-be-pushed content;
determining second sub-content required for each of the platform fields in the to-be-pushed content; and
determining a field value of the common field according to the first sub-content, and determining a field value of each of the platform fields according to the second sub-content to obtain the first target content to be pushed to each of the content platforms.

15. The electronic device according to claim 14, wherein the method further comprises:
when the to-be-pushed content is updated, updating a field value of the common field corresponding to the to-be-pushed content in the common field library and/or updating a field value of the platform field corresponding to the to-be-pushed content in the common field library, to obtain a second target content to be pushed to each of the content platforms; and
updating and displaying the first target content displayed on each of the content platforms, according to the second target content.

16. The electronic device according to claim 15, wherein the updating and displaying the first target content displayed on each of the content platforms, according to the second target content comprises:
updating and displaying the first target content displayed on each of the content platforms in real time, according to the second target content; or
displaying content update prompt information, and updating and displaying, in response to an update operation triggered by a user, the first target content displayed on each of the content platforms, according to the second target content.

17. The electronic device according to claim 11, wherein the method further comprises:
adding, in response to a field addition operation, the common field and/or the platform field corresponding to the to-be-pushed content in the common field library; or
querying, in response to a field edit operation, the common field and/or the platform field corresponding to the to-be-pushed content in the common field library, and editing the common field and/or the platform field that are queried, according to the field edit operation.

18. The electronic device according to claim 11, wherein a field corresponding to the to-be-pushed content in the common field library has a field operation permission, and the method further comprises:
sharing, in response to an operation of authorizing the field operation permission of the to-be-pushed content to a target user, the common field and/or the platform field corresponding to the to-be-pushed content with a terminal device of the target user, and allowing the target user to modify the common field and/or the platform field corresponding to the to-be-pushed content.

19. The electronic device according to claim 11, wherein the field information in the common field library is obtained by:
determining visual content, of which content types are the same as that of the to-be-pushed content, displayed to a user on different content platforms;
determining a same first field when each of the content platforms displays corresponding visual content, and determining a different second field when each of the content platforms displays the corresponding visual content; and
storing the first field into the common field library as the common field, and storing the second field into the common field library as the platform field of each of the content platforms.

20. The electronic device according to claim 11, wherein the to-be-pushed content is physical commodity content and/or service commodity content.
